(19) United States
(12) Patent Application Publication
(10) Pub. No.: US 2005/0112041 A1
(43) Pub. Date: May 26, 2005

(54) Method for producing higher purity zinc oxide

(76) Inventors: Deane A. Horne, Toledo, OH (US); James Alan Thornton, Maumee, OH (US)

Correspondence Address: TECHNOPROP COLTON, L.L.C., P O BOX 567685, ATLANTA, GA, 311567685, US

(21) Appl. No.: 10/719,561

(22) Filed: Nov. 21, 2003

(51) Int. Cl. C01G 9/00; C01G 11/00; C01G 13/00; C22B 17/00; C22B 19/00; C22B 43/00; C01G 9/02

(52) U.S. Cl. 423/99; 423/622

(57) ABSTRACT

A method for producing higher purity zinc oxide by thermal treatment of the preprocessed material for a defined period of time.

### BACKGROUND OF THE INVENTION

1. Technical Field

The present invention relates generally to a method and process for producing a higher purity zinc oxide product. The present invention also relates generally to the treatment of industrial waste streams comprising zinc oxide and/or zinc-containing residues to recover a high purity zinc oxide containing product. The present invention relates more specifically to a method and process of subjecting preprocessed waste stream materials comprising zinc oxide and/or zinc-containing residues, from for example electric arc furnace (EAF) dust, to thermal processing for recovering higher purity zinc oxide and/or for further purifying the zinc oxide-containing residue into a higher purity zinc oxide.

2. Prior Art.

Zinc oxide is a commercially valuable product. Zinc oxide is a white powder that has a variety of uses including as an accelerator activator, as a pigment, as a dietary supplement, as a rubber tire component, and in the semiconductor field. Although there are many available sources of zinc oxide mixed with other components, higher purity zinc oxide products are preferred in many industries. For example, the automotive tire industry utilizes zinc oxide, and the specification for tire grade zinc oxide is technically demanding.

One source of zinc oxide is the steel industry. The worldwide steel industry produces over a billion tons of crude steel each year. As a consequence of this steel production, a substantial amount of waste material is produced. This waste material, often in the form of steel refining dust or fly ash, may be potentially harmful to the environment due to the presence of cadmium and lead. In processes using an electric arc furnace (EAF) or a basic oxygen furnace (BOF), a metric ton of liquid steel can result in about 10 kg of steel refining dust as a waste stream. This EAF or BOF waste material often has zinc oxide as a component. This mill dust can contain zinc oxide at a concentration of about 25 percent. As zinc oxide has a substantial commercial value, it is advantageous to recover as much zinc oxide from the waste stream as possible.

Methods for recovering and recycling zinc oxides from crude product, including recovering zinc oxide from industrial waste materials, are known in the art. For example, U.S. Pat. No. 5,601,631 to Rinker discloses a process for treating metal oxide fines that discloses a series of steps that includes combining the oxide fines with carbonaceous material, forming green compacts and heating the compacts at temperatures greater than about 1093° C. U.S. Pat. Nos. 6,395,060 and 6,464,753 to Horne disclose a method of processing zinc oxide rich mill dust that includes a process of mixing the dust with carbonaceous material, heating the mixture to cause the zinc component to become gas-borne and separating the gas-borne material from the non gas-borne material. U.S. Pat. Nos. 5,208,004 and 5,759,503 to Myerson disclose methods for further purifying zinc oxide from a waste stream. U.S. Pat. No. 5,667,553 to Keegel discloses a method for treating raw material, such as EAF dust, which comprises a mixture of metals, with a combination of pyrometallurgical and hydrometallurgical treatment steps, to separate and recover metals selected from the group consisting of iron, cadmium, zinc, and lead. U.S. Pat. No. 4,071,357 to Peters discloses a process for recovering a substantially pure zinc oxide from steel-making flue dust or other comparable waste materials.

The rubber tire and molding industry is the single largest user of zinc oxide, consuming over 66% of the zinc oxide produced in the year 2002. While current processes including those briefly mentioned above produce a zinc oxide residue appropriate for some applications, many of them do not meet the demanding purity and morphology specifications for zinc oxide used in the rubber industry. For the zinc oxide needed in the rubber industry, it would be optimal to produce a zinc oxide material that is greater than 98% zinc oxide and also has a specific surface area of between 4 and 6 square meters per gram (m²/g). However, methods to improve the recycled zinc oxide purity have been difficult to develop and perfect partly because it is unclear exactly what impurities remain in the zinc oxide produced by these methods. For example, several tests using the prior art methods referenced above, using reagent grade zinc oxide (99.99% pure) and reagent grade reducers have resulted in a zinc oxide product containing less than 98% zinc oxide. Many processes, including those mentioned above, can benefit from the present invention to increase the purity of the resulting zinc oxide.

Accordingly, there is need for an improved method for purifying zinc oxide in general and specifically from zinc oxide-containing residues from recycled industrial waste streams. There also is a need for a method that can be used to treat residue from industrial waste streams containing zinc oxide of a first purity level to obtain zinc oxide material that has a greater purity level and specific surface area of between 4 and 6 square meters per gram. There also is a need for a method for removing impurities from lower purity zinc oxide and from zinc oxide-containing residue that is more efficient and/or cost effective. There also is a need for a process or method that can augment the results of prior art methods for recovering and purifying zinc oxide. It is to these needs and others that that the present method is directed.

### BRIEF SUMMARY OF THE INVENTION

Briefly, the present invention is a method and process for improving the purity of zinc oxide recovered from industrial waste streams. The present invention can be used to achieve a material with an improved purity of zinc oxide by lowering the percentage of chlorides, carbonates and other impurities and not substantially degrade the material's surface area properties. Preferably, the purification process can improve the zinc oxide percentage in streams containing zinc oxide to over 98% zinc oxide by mass, reduce the chloride percentage to less than 0.8% chloride, and achieve a surface area between 3 and 7 square meters per gram (m²/g). More preferably, the purification process can improve the zinc oxide percentage to over 99% zinc oxide by mass, reduce the chloride percentage to less than 0.4%, and achieve a surface area to between 4 and 6 square meters per gram (m²/g).

Purifying zinc oxide by heating is known. Heating zinc oxide to temperatures above 300° C. causing the zinc oxide particles to sinter also is known. However, based on the discovery herein that the sintering process is slower than the impurity removal process, the present invention involves heating the zinc oxide to high temperature for short periods of time resulting in a purer zinc oxide product while reducing the degree of sintering so as to maintain a small particle size, which is reflected in the surface area of the product. For example, heating the zinc oxide to temperatures of 600° C. and higher for periods of time of 30 minutes or less has resulted in the production of zinc oxide product having a surface area of between 4 and 6 m²/g that can pass through a 325 mesh (US; 44 μm) sieve, which is highly desired for many applications and downstream processes.

One embodiment of the present invention is a method or process of subjecting preprocessed waste stream materials comprising zinc oxide and/or zinc-containing residues, from, for example electric arc furnace (EAF) dust processing, to thermal processing for recovering higher purity zinc oxide and/or for further purifying the zinc oxide-containing residue into a higher purity zinc oxide while maintaining, or even improving the specific surface area of the product. This embodiment of the present invention comprises subjecting the zinc oxide-containing material to a subsequent thermal purification process for a defined period of time.

The preliminary process can be one of the many prior art processes for recovering zinc oxide from a waste stream. The preliminary process is generally able to remove impurities from the waste stream and obtain a zinc oxide product with an improved purity of zinc oxide. As mentioned previously, such preliminary processes can be found in the prior art and can include methods and processes in for examples U.S. Pat. No. 4,071,357 to Peters, U.S. Pat. No. 4,673,431 to Briemont, U.S. Pat. No. 5,667,553 to Keegel, Jr., U.S. Pat. No. 5,601,631 to Rinker, U.S. Pat. No. 5,759,503 to Myerson, and U.S. Pat. Nos. 6,395,060 and 6,464,753 to Horne.

After the waste material has been preliminary processed, a subsequent purification process further treats the product material or preprocessed material. While the processing temperature can vary with specific application, the temperature at which the material is heated during the purification process is over 600° C. but less than 800° C., and preferably in the 620° C. to 700° C. range, for a defined period of time. In one illustrative embodiment, the purification process removes impurities from the zinc oxide component of the material without substantially changing the morphology of the zinc oxide material by thermally processing the material at about 683° C. for about 10 to 15 minutes.

It was found that there is a general trend between the temperature and duration of the thermal processing and the properties of the zinc oxide containing product. More specifically, while the use of higher temperature thermal processing appears to remove contaminates in a shorter period of time, the use of higher temperatures also appears to degrade the morphology by sintering the zinc oxide particles. Thus, one of ordinary skill in the art can select a temperature and heating duration so to maximize a preselected condition. Thus, during the purification process, the preprocessed material, that is the feed from a prior art process, is thermally processed for a defined period of time that is preferably between 1 minute and 90 minutes. More preferably, the material in the purification process is thermally processed for a period of time between 5 and 30 minutes. Most preferably, the material subjected to the purification process is thermally processed for a period between 10 and 20 minutes.

The present invention provides a relatively simple step that can be added to prior art waste stream recovery processes for the recovery of high purity zinc oxide. In many cases, the preliminary step does not need to be modified for the implementation of the purification process. In fact, as the purification step does not require the addition of agents, the second step can be incorporated into a prior art process without undue experimentation.

These features and other features and advantages of the present invention will become more apparent to those of ordinary skill in the relevant art when the following detailed description of the preferred embodiments is read in conjunction with the appended drawing in which like reference numerals represent like components throughout the several views.

### BRIEF DESCRIPTION OF THE DRAWINGS

FIG. 1 is a schematic diagram of one embodiment of the present invention.

FIG. 2 is a kinetics diagram of a zinc oxide residue processed by the embodiment shown in FIG. 1.

### DETAILED DESCRIPTION OF PREFERRED EMBODIMENTS

Illustrative embodiments of the present invention are methods and processes for reclaiming and purifying zinc oxide containing residues, such as from a waste stream containing zinc compounds. Preferred embodiments of the present invention can be used to recover and purify such zinc oxide residues from an array of commercial waste streams including an electric arc furnace (EAF), a basic oxygen furnace (BOF), steel mill waste, and rolling mill scale, all of which are collected in the normal course of steel production. While the present invention is described herein in conjunction with the preferred and illustrative embodiments, it will be understood that the present invention is not limited to these embodiments.

The present invention can be employed to produce a zinc oxide material with desired properties. One embodiment can be used to produce a zinc oxide material with a content of zinc oxide over 98% by mass, a chloride content of less than about 0.4%, a surface area between 4 and 6 m²/g, and passing a 325-mesh (US, 44 μm) sieve. One of ordinary skill in the art can adjust the present invention to prepare zinc oxide material for various applications with various specifications.

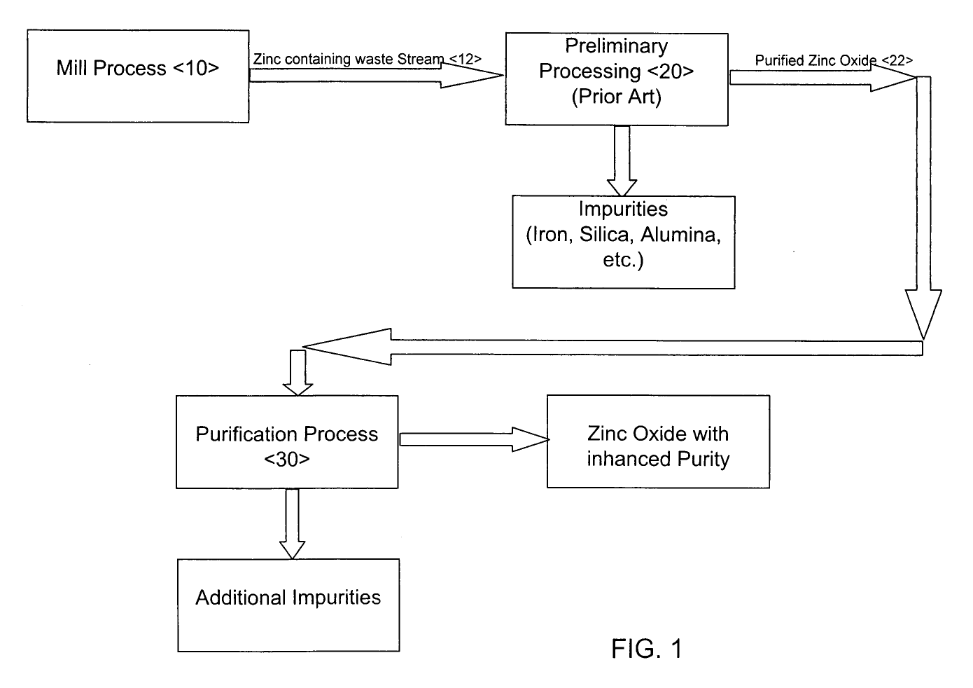

Referring to FIG. 1, one embodiment of the present invention is a process designed to purify zinc oxide-containing material from a waste stream 12, such as dust from an EAF or other mill process 10 that is high in zinc content. As shown, this embodiment comprises two processes that together recover and purify zinc oxide containing residue from commercial waste stream. More particularly, this embodiment is a process for recovering and purifying zinc oxide residues from waste materials comprising:
(1) a preliminary process 20, such as prior art zinc oxide recovery methods, in which the zinc-containing waste stream 12 of mill process 10 is subjected to a series of leaching and reduction steps to produce a preprocessed purified zinc oxide material 22; and
(2) a subsequent purification process 30 comprising thermally treating the preprocessed purified zinc oxide material 22 at a defined temperature for a defined period of time to produce zinc oxide with improved purity and morphology.

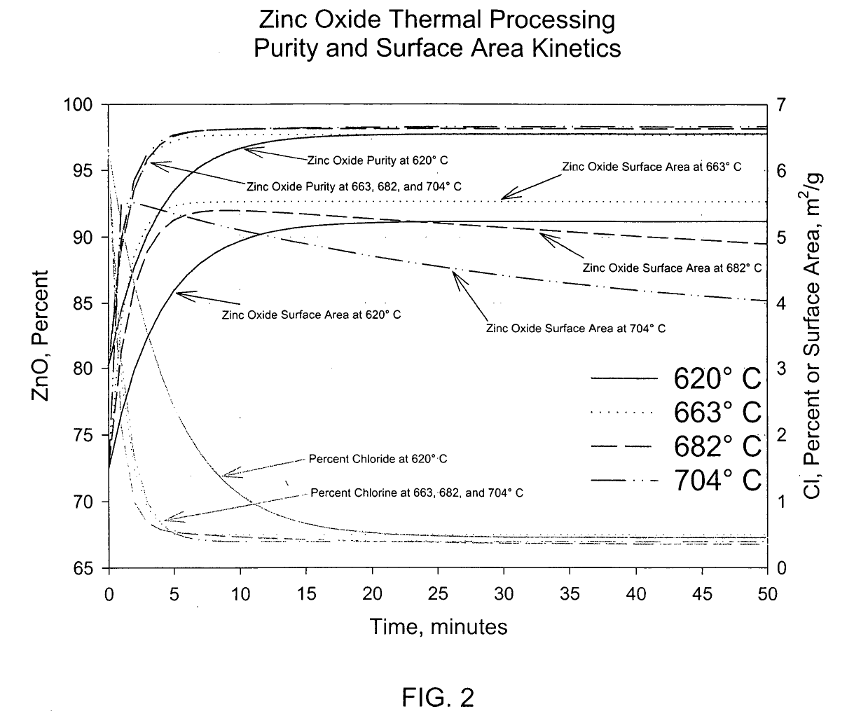

FIG. 2 generally is a kinetics diagram of a zinc oxide residue processed by the embodiment shown in FIG. 1. In this illustration the primary impurity was chloride, but it could have been carbonate, hydroxide, or other chemically similar anion(s). Note that the rate at which impurities are removed, as illustrated by chloride content, is much faster than the rate at which the morphology degrades, as demonstrated by the surface area. Initially the surface area increases because impurities that are masking the true morphology of the zinc oxide particle are removed. Longer residence times and higher temperatures cause this initial gain in surface area to decrease. Note in particular the rapid rise in surface area at 704° C. as the true morphology of the particles is revealed followed by a subsequent decrease as the particles sinter.

1. A General Preliminary Process Reclaiming Zinc Oxide Containing Residue From a Waste Stream.

Exemplary preliminary processes for producing a preprocessed zinc oxide material from waste material, typically a fly ash or flue dust such as EAF, are numerous. Preliminary processes can upgrade the crude zinc oxide produced from the EAF dust. Such methods are known in the prior art and can be used to produce a preprocessed material.

As the product of this process, namely the preprocessed material, will be treated further in a subsequent process, it is not necessary for the zinc oxide-containing material to be substantially pure zinc oxide. In one embodiment, the preliminary process can be almost any process or method that can produce material that contains zinc oxide or other zinc compound that can be converted to zinc oxide by thermal treatment. Preferably, the preliminary process should reduce the level of trace elements such as iron, lead, cadmium, and sulfur. As a purer preprocessed material can lead to a purer product material, it can be advantageous to select a preliminary processing method that is able to prepare a material is rich in zinc oxide and low in trace metal content.

The preliminary method can reclaim and recover a material that is greater than 70% zinc oxide from the initial material. Preferably, the methods will reclaim and recover a material that is about at least 80% zinc oxide from the initial material. Most preferably, the methods will reclaim and recover a material that is at least 98% zinc oxide. The purity of the preprocessed material will depend on the preliminary process used to purify the zinc oxide-containing material.

The purified zinc oxide also should have an adequate surface area property. As the surface area property can relate to the ability of the zinc oxide to disperse in an organic slurry, the optimal surface area can vary with the application. As one important usage for zinc oxide is as an activator in the rubber industry, it is important to obtain a product that disperses well in rubber slurry. However the inorganic zinc oxide is not easily dispersed in an organic rubber polymer if the surface area property (which can be measured by nitrogen absorption) is higher than 6 m²/g or lower than 3 m²/g. Preferably, a material with between 4 m²/g and 6 m²/g is produced by the preliminary method. The preferred surface area properties of the material will depend on the application of the final product.

Further, a significant portion of the preprocessed material should be able to pass through a selected mesh sieve. Although the mesh size of the zinc oxide product is not of major consequence, large chucks of material may reduce the effect of the thermal processing on the material. Preferably, most of the product of the preliminary process will pass a 325-mesh (US, 44 μm) sieve. The preferred mesh passage rate will depend on the ultimate use of the final product.

Preliminarily processes for recovering and initially purifying crude zinc oxide material are known in the art. Such preliminary processes can be found in the prior art and can include methods and processes in for examples U.S. Pat. No. 4,071,357 to Peters, U.S. Pat. No. 4,673,431 to Briemont, U.S. Pat. No. 5,667,553 to Keegel, Jr., U.S. Pat. No. 5,601,631 to Rinker, U.S. Pat. No. 5,75,9503 to Myerson, and U.S. Pat. Nos. 6,395,060 and 6,464,753 to Horne, or a combination of these processes. One of ordinary skill in the art can select an adequate preliminary process without undue experimentation.

2. A Subsequent Purification Process Comprising Thermally Processing the Preprocessed Material For a Defined Period of Time.

After the zinc oxide material has been processed in the preliminary process, the material or preprocessed material is then further processed through a subsequent purification process. The purified zinc oxide remaining after preliminary step can contain carbonates, chlorides, and possibly some other impurities, and it is necessary to process the material further. Thus, the material is generally processed in a subsequent process that involves thermally processing the material at a defined temperature for a defined period of time. This purification process is used improve the purity of the zinc oxide.

The purification process can be the last step in the processing of the zinc oxide. By adding the purification process as the last step of the overall process to recover and purify zinc oxide-containing residue, it is possible to improve the purity of the product zinc oxide material and reduce the chloride, carbonate, or other chemically similar anion concentration without having to change prior processing methods. As such, the purification step can be added to various prior art processes without undue experimentation.

In one illustrative embodiment, the preprocessed material obtained from the preliminary step is thermally processed for a defined period of time. During the thermal process, contaminates are removed by vaporization and the sintering of the zinc oxide particles causes particle growth. For example, while the vaporization improves the purity of zinc oxide in the material, the sintering process reduces the particle surface area (increases particle size), which thereby decreases the fraction of the product that will have a defined mesh property. As the preprocessed material is thermally processed, these processes are potentially competing, higher purity zinc oxide is more valuable, but low surface area decreases the value for some end uses and the value of the product is controlled by the final properties of the product. Further, as shown in FIG. 2, there is a general trend between higher thermal processing temperatures and degradation of surface area of the zinc oxide product. While processing at high temperatures can prepare products with a higher purity of zinc oxide with lower chloride content at a faster rate, processing at high temperature also results in a product with a lower surface area property. Initially, the high temperature processing may cause the surface area to increase rapidly because contaminates are removed, unmasking the hidden morphology of the zinc oxide particle, but at some point the process can cause the surface area of the product to decay over time as the particles sinter and fuse. A kinetic evaluation shows that most of the impurities can be removed in the first 20 minutes of exposure to temperatures and significant degradation of surface area occurs after this period of time.

Further, while the purity of zinc oxide in zinc oxide containing residues improves over time using thermal processing, the enhancement to the purity of the zinc oxide is maximized during the earlier minutes of the thermal processing. More particularly, the improvement in purity begins immediately upon thermal processing and has substantially improved in purity after approximately 10 minutes. As the thermal processing is performed, the rate of improvement in purity of the material with time diminishes. At some time period (for example 20 minutes), further thermal processing may not significantly improve the overall zinc oxide purity of the sample.

Preferably, during the subsequent purification process, the preprocessed material is heated to temperatures above 600° C. but less than 800° C. For example, as diamino zinc dichloride decomposes at 271° C. and ammonium chloride sublimes at 340° C., heating at a temperature above 340° C. is useful. To ensure that the material is as free of impurities as possible, however, it is preferable to thermally process the zinc oxide containing residue to even higher temperatures because, for example, zinc chloride boils at 726° C. The better results were obtained when the zinc oxide material was thermally processed at approximately 663° C. to 683° C. for about 10 to 20 minutes, with a broader temperature range of approximately 620° C. to 700° C. for about 5 to 90 minutes.

As such, embodiments of the present invention provide a new and improved method to purifying zinc oxide containing residues from commercial waste streams that is disclosed herein for the first time. The new and improved process is fully compatible with an array of prior art techniques and can be integrated into such technique without undue experimentation.

### EXAMPLES

The following examples illustrate preparation and processing methods as well as properties of various embodiments of the invention. The following examples are not intended to limit or depart from the scope and spirit of the invention.

### Example 1

Samples of crude zinc oxide containing waste were obtained from a steel plant or EAF stream. After the waste was treated using a prior art method for reclaiming zinc oxide, the product material contained 81 % zinc oxide by mass and 6.2% chloride by mass, and a surface area of 1.5 m²/g. The feed, in test sets, was then subjected to thermal processing at 683° C. for 20 minutes and the products were analyzed to ascertain composition, surface area, and mesh properties.

The results, as shown in Table 1, show that thermal processing is effective in removing impurities from the processed samples without substantially degrading the material's surface area property. In the four test sets, the feed was obtained from a prior art process and two samples of the feed were subjected to thermal processing for 20 minutes at 683° C. In these cases, thermally processing substantially improved the purity of the sample and did not substantially degrade material's surface area property.

TABLE 1

| | | | | Surface | % Pass 325 |
|---|---|---|---|---|---|
| Test Set | Sample | % ZnO | % Cl | Area (m²/g) | Test Mesh |
| 1 | Feed | 95.57 | 1.31 | 3.67 | 97.2 |
| | Product 1 | 98.70 | 0.35 | 3.60 | 99.6 |
| | Product 2 | 98.95 | 0.47 | 4.43 | 99.0 |
| 2 | Feed | 83.52 | 8.15 | 1.16 | n/a |
| | Product 1 | 89.97 | 4.84 | 3.05 | |
| | Product 2 | 91.70 | 4.17 | 2.04 | |
| 3 | Feed | 87.40 | 5.95 | 2.19 | 97.8 |
| | Product 1 | 98.83 | 0.58 | 5.17 | 99.7 |
| | Product 2 | 98.97 | 0.54 | 5.14 | 99.7 |
| 4 | Feed | 96.33 | 0.85 | 4.17 | 99.7 |
| | Product 1 | 98.56 | 0.32 | 5.00 | 99.6 |
| | Product 2 | 98.60 | 0.32 | 4.61 | 99.9 |

### Example 2

Samples of crude zinc oxide were thermally processed and compared to a zinc oxide sample prepared using 99.9% pure zinc oxide and ammonium chloride. More particularly, samples 1 and 3 of pure zinc oxide material and zinc oxide crude, respectively, were allowed to air dry, while samples 2 and 4 of pure zinc oxide precipitate and zinc oxide crude, respectively, were treated with heat at 620° C. for 2 hours. Samples 3 and 4 were washed once with a prior art method.

The results, as shown in Table 2, show that thermally processing the crude zince oxide containing residue does improve the purity of the zinc oxide material. Air-drying alone does not improve the purity of the pure zinc oxide precipitate but applying thermal processing to the sample improves the percentage of zinc oxide substantially. Further, thermally processing the washed zinc oxide crude in sample 4 improves the percentage of zinc oxide in the sample. In all cases, it appears that the thermal processing removes or reduces the chloride impurity in the sample.

TABLE 2

| | | Drying | | |
|---|---|---|---|---|
| Sample No. | Washed | time/temperature | % ZnO | % Cl |
| 1 | No | 2 hours/110° C. | 92.0 | 2.37 |
| 2 | No | 2 hours/620° C. | 99.1 | 0.07 |
| 3 | Yes | 2 hours/110° C. | 96.1 | 0.84 |
| 4 | Yes | 2 hours/620° C. | 98.6 | 0.09 |

### Example 3

Samples of crude zinc oxide containing residue from a typical waste stream treated with thermal processing for 2 hours at 620° C. show a reduction in sulfur. More particularly, sample 1, which upon preprocessing had a zinc oxide concentration of 78% and a sulfur concentration of 0.29%, had the characteristics shown in Table 3 after thermal processing. The data shows that the thermal processing significantly reduces the percentage sulfur in the resulting material.

TABLE 3

| Sample | | Drying | | |
|---|---|---|---|---|
| No. | Washed | time/temperature | % ZnO | % Sulfur |
| 1 | No | 2 hours/620° C. | 98.4 | 0.006 |

### Example 4

Samples of preprocessing zinc oxide containing residue treated with thermal processing for 12 hours at 620° C. show a substantial reduction of impurities. Specifically, sample 1 is crude zinc oxide from a typical waste stream that has been process by a prior art method and thermally processed for 12 hours. Before the thermal processing, samples contained approximately 97% zinc oxide by mass. After thermal processing, the samples have the composition analysis shown in Table 4. While the ZnO constitutes over 99% of the sample and the same has a reduced chloride concentration, the surface area is substantially reduced after 12 hours.

TABLE 4

| Component | Amount |
|---|---|
| ZnO | 99.2% |
| Chloride | 0.32% |
| Lead | 13.3 ppm |
| Iron | 12.7 ppm |
| Copper | 1.1 ppm |
| Cd | 1.0 ppm |

### Example 5

The surface area properties of the zinc oxide containing residue remains relatively stable after 20 minutes of thermal processing. As shown in Table 5, samples processed 20 minutes showed relatively stable surface area properties and mesh properties. In fact, the surface area of the thermally processed sample remained within the range of 3 and 6 m²/g after the processing. In contrast, when the sample was processed thermally for 40 minutes or more, the surface area and mesh properties dropped down substantially. Thus, the data shows that thermally processing the material for a longer period of time results in a decrease in the specific surface area of the product.

TABLE 5

| Sample | Processing | Surface Area | % Pass 325 |
|---|---|---|---|
| No. | Time (minutes) | (m²/g) | Mesh |
| 1 | 20 | 3.52 | 99.4 |
| 2 | 20 | 5.48 | 99.2 |
| 3 | 20 | 4.76 | 99.9 |
| 4 | 40 | 1.33 | N/A |

### Example 6

A zinc oxide material from a prior art method was obtained and was found to be composed 81% zinc oxide, 6.2% chloride, and 12.8% other impurities and to have a surface area of 1.5 m²/g. A nickel combustion boat was filled with about 5 grams of dry zinc oxide and placed into a preheated tube furnace for a preset period of time. The samples were then collected during defined time intervals from 5 minutes to 90 minutes at 620° C. and subsequently repeated at 663° C., 682° C. and 704° C. The results of this experiment in the form of a kinetic curve is shown in FIG. 2

The kinetic curves of FIG. 2 are in three groups, namely, one for zinc oxide content, one for chloride content, and one for the surface area property. There is a general trend; higher temperatures produce higher purity zinc oxide with a lower chloride content in a shorter time period. Further, while higher temperatures cause the surface area to increase rapidly as contaminates are removed, which unmasks the hidden morphology of the zinc oxide particle, the surface area begins to decay at longer residence times as the particles sinter and fuse. Thus, there appears to be a trade off between higher zinc oxide purity and degradation of the material's surface area.

### Example 7

Material obtained from a process embodying the technology of the hydrometallurgical zinc oxide recovery process disclosed in U.S. Pat. No. 5,759,503 to Myerson was thermally processed to prepare a high-grade zinc oxide material. This material contained 96.3% zinc oxide, 0.85% chloride and had a specific surface area of 4.2 m²/g. The Myerson material was thermally processed at 683° C. for 20 minutes to produce a zinc oxide product that contained 98.6 to 99% zinc oxide by mass and 0.32% chloride by mass. The product had a surface area between 4.2-5.0 m²/g and that between 99.6-99.9% passed a 325-mesh (US, 44 μm) sieve.

As can be seen by this disclosure, the addition of a thermal processing step for a limited period of time can purify a zinc oxide product to desired commercially valuable levels. The various processing times and temperatures are provided to show the best mode of the invention known to the inventor at this time, but other processing times and temperatures can be determined by those of ordinary skill in the art without undue experimentation. While the above description sets forth the best mode of the invention as known to the inventor at this time, and is for illustrative purposes only, as it is obvious to one skilled in the art to make modifications to this process without departing from the spirit and scope of the invention and its equivalents as set forth in the appended claims.

1. A process for further purifying a preprocessed zinc oxide containing residue comprising thermally processing the material at a temperature between 400 and 700° C. for a period of time.

2. The process as claimed in claim 1, wherein the temperature is greater than 600° C.

3. The process as claimed in claim 2, wherein the temperature is between 600° C. and 700° C.

4. The process as claimed in claim 1, wherein the time period is greater than 5 minutes.

5. The process as claimed in claim 4, wherein the time period is greater than 1 hour.

6. The process as claimed in claim 5, wherein the time period is greater than 2 hours.

7. The process as claimed in claim 1, whereby the product comprises zinc oxide and has a surface area between 4 and 6 square-meters per gram.

8. The process as claimed in claim 1, wherein the process is the final step after a prior purification process.

9. The process as claimed in claim 1, whereby the process improves the purity of the zinc containing material from under 60 percent to over 60 percent by mass.

10. The process as claimed in claim 1, wherein the process improves the purity of zinc oxide from under 98 percent to over 98 percent by mass.

11. The process as claimed in claim 1, wherein the process improves the purity of zinc oxide to greater than 98 percent by mass.

12. The process as claimed in claim 1, resulting in a zinc oxide product has a surface area of between 3 m²/g and 7 m²/g.

13. The process as claimed in claim 12, wherein the zinc oxide product has a surface area of between 4 m²/g and 6 m²/g.

14. The process as claimed in claim 10, resulting in a zinc oxide product has less than 0.8% chlorides by mass.

15. The process as claimed in claim 14, wherein the zinc oxide product has less than 0.4% chlorides by mass.

16. A method of recovering zinc oxide from a metal waste containing zinc oxide state and impurities comprising:
a. a preliminary process comprising mixing the waste and a reducing material to create a preprocessed zinc oxide containing material; and
b. a purification process of thermally processing the preprocessed zinc oxide containing material for a defined period of time.

17. The method according to claim 16, wherein the preprocessed material is thermally processed at a temperature greater than 400° C.

18. The method according to claim 17, wherein the preprocessed material is thermally processed at greater than 600° C.

19. The method as claimed in claim 18, wherein the preprocessed material is thermally treated at a temperature of between 600° and 700° C.

20. The method as claimed in claim 16, wherein the defined period of time is greater than 5 minutes

21. The method as claimed in claim 20, wherein the defined period of time is greater than 1 hour.

22. The method as claimed in claim 21, wherein the defined period of time is greater than 2 hours.

23. The method as claimed in claim 16, wherein the process improves the purity of zinc oxide in the material.

24. The process as claimed in claim 16, resulting in a zinc oxide product has a surface area of between 3 m²/g and 7 m²/g.

25. The process as claimed in claim 24, wherein the zinc oxide product has a surface area of between 4 m²/g and 6 m²/g.

26. The process as claimed in claim 23, resulting in a zinc oxide product has less than 0.8% chlorides by mass.

27. The process as claimed in claim 26, wherein the zinc oxide product has less than 0.4% chlorides by mass.

28. A method for recovering zinc oxide from a metal waste containing zinc oxide and impurities comprising:
processing the waste with a reducing material to create a preprocessed zinc oxide containing material;
heating the zinc oxide containing material at a temperature above 400° C. for a period of time greater than 5 minutes,
whereby the heating of the zinc oxide containing material increases the purity of the zinc oxide without substantially degrading the surface area of the material.

29. The method as claimed in claim 28, wherein the temperature is above 600° C.

30. The method as claimed in claim 29, wherein the temperature is between 600° C. and 700° C.

31. The method as claimed in claim 30, wherein the temperature is 683° C.

32. The process as claimed in claim 28, resulting in a zinc oxide product has a surface area of between 3 m²/g and 7 m²/g and has less than 0.8% chlorides by mass.

33. The process as claimed in claim 32, wherein the zinc oxide product has a surface area of between 4 m²/g and 6 m²/g and has less than 0.4% chlorides by mass.

34. A method for recovering zinc oxide from a metal waste containing zinc oxide and impurities comprising:
processing the waste with a reducing material to create a preprocessed zinc oxide containing material;
heating the zinc oxide containing material at a temperature between 600° C. and 700° C. for a period of time between 5 minutes and 2 hours,
whereby the heating of the zinc oxide containing material increases the purity of the zinc oxide without substantially degrading the surface area of the material.

35. The method as claimed in claim 34, wherein the temperature is between 620° C. and 700° C.

36. The method as claimed in claim 35, wherein the time is between 20 minutes and 2 hours.

37. The process as claimed in claim 36, resulting in a zinc oxide product has a surface area of between 3 m²/g and 7 m²/g and has less than 0.8% chlorides by mass.

38. The process as claimed in claim 37, wherein the zinc oxide product has a surface area of between 4 m²/g and 6 m²/g and has less than 0.4% chlorides by mass.
